(19) United States
(12) Patent Application Publication
(10) Pub. No.: US 2005/0108752 A1
(43) Pub. Date: May 19, 2005

(54) 3-Dimensional browsing and selection apparatus and method

(75) Inventors: Yuko Nishikawa, La Jolla, CA (US); Dayan Golden, San Diego, CA (US); Michael A. Bergeron, Poway, CA (US); Himgan Wibisono, San Francisco, CA (US); Philip McKay, San Francisco, CA (US)

Correspondence Address: FITCH EVEN TABIN & FLANNERY, 120 SOUTH LASALLE SUITE 1600, CHICAGO, IL, 60603, US

(73) Assignees: Sony Corporation, a Japanese corporation, Tokyo (JP); Sony Electronics Inc., a Delaware corporation, Park Ridge, NJ (US)

(21) Appl. No.: 10/806,713

(22) Filed: Mar. 23, 2004

Related U.S. Application Data
(60) Provisional application No. 60/520,752, filed on Nov. 17, 2003.

(51) Int. Cl. H04N 7/16; G06F 13/00; H04N 5/445; H04N 7/173

(52) U.S. Cl. 725/39; 725/44; 725/38

(57) ABSTRACT

A content guide, such as a program guide for use with a plurality of audio/visual programs, has a browsing and selection interface that comprises a two-dimensional display that presents three spatial dimensions of a three-dimensional object. This object (or objects) bear at least some characterizing descriptors that correspond to various program options available to a viewer. In a preferred embodiment the browsing and selection interface comprises a plurality of cylinders. A viewer can cause these cylinders to rotate to present previously hidden characterizing information for review and/or selection by the viewer.

### PROVISIONAL APPLICATIONS

We claim the benefit of Provisional Patent Application No. 60/520,752, entitled “Ring Interface for TV Programming Guide” and as filed on Nov. 17, 2003.

### RELATED APPLICATIONS

This application relates to each of the following applications, each of which is commonly owned and was filed on an even date herewith and each of which is hereby incorporated by this reference:

INTERACTIVE PROGRAM GUIDE WITH PREFERRED ITEMS LIST APPARATUS AND METHOD (attorney's docket number 81233);

DISPLAY FILTER CRITERIA AND RESULTS DISPLAY APPARATUS AND METHOD (attorney's docket number 81234);

FILTER CRITERIA AND RESULTS DISPLAY APPARATUS AND METHOD (attorney's docket number 81205);

AUTOMATIC CONTENT DISPLAY APPARATUS AND METHOD (attorney's docket number 81232);

CANDIDATE DATA SELECTION AND DISPLAY APPARATUS AND METHOD (attorney's docket number 81229);

MULTI-SOURCE PROGRAMMING GUIDE APPARATUS AND METHOD (attorney's docket number 81235).

### TECHNICAL FIELD

This invention relates generally to information displays and more particularly to browsing and selection interfaces as used with content guides.

### BACKGROUND

Information displays of various kinds are essentially ubiquitous in modem society. Many such displays serve, at least in part, to present content options to a viewer. As the number, kind, and constitution of such content options expand, a concurrent challenge arises to facilitate a way to navigate such options in a manner that is helpful and meaningful to the viewer.

Interactive programming guides are an example of such challenges. With cable, fiber, and/or satellite broadband services facilitating the delivery of an increasing number of varied programming options at any given time, it becomes more important to present a viewer with useful and helpful interface mechanisms to permit the viewer to be informed regarding available content options as the sheer magnitude of programming options renders unlikely the possibility that the viewer will be otherwise sufficiently knowledgeable in this regard.

Present suggestions regarding interactive programming guides as used with various audio/visual content services often present a number of candidate programming options on a display. In some cases this display will include a short textual description of the content of one or more of the candidate programming options or other static information (such as a rating, a brief listing of key actors, a year of publication, and the like). Navigation of such displays is not always sufficiently intuitive and/or aesthetically pleasing to all viewers. As a result, some viewers may fail to attain the full benefit of the available information and thereby fail to achieve satisfactory benefit of their programming options.

### BRIEF DESCRIPTION OF THE DRAWINGS

The above needs are at least partially met through provision of the 3-dimensional browsing and selection apparatus and method described in the following detailed description, particularly when studied in conjunction with the drawings, wherein:

FIG. 1 comprises a block diagram as configured in accordance with various embodiments of the invention;

FIG. 2 comprises a flow diagram as configured in accordance with various embodiments of the invention;

FIG. 3 comprises a display as configured in accordance with various embodiments of the invention;

FIG. 4 comprises a detail view of a display as configured in accordance with various embodiments of the invention; and

FIG. 5 comprises a display as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

Generally speaking, pursuant to these various embodiments, characterizing descriptors as individually correspond to a plurality of discrete selectable items of audio/video content are provided. A program guide simultaneously displays a plurality of these characterizing descriptors for each of the plurality of discrete selectable items using a browsing and selection interface that bears at least some of the characterizing descriptors and wherein three spatial dimensions for the browsing and selection interface are simultaneously displayed, such that the browsing and selection interface is depicted on a two dimensional display as at least one three-dimensional object.

So configured, a viewer can intuitively and in a pleasing-to-the-user manner navigate the information provided. Even relatively densely displayed informational content can often nevertheless be presented and successfully navigated without necessitating undue cognitive loading of the user.

In some embodiments a plurality of such three-dimensional objects are utilized to further leverage these benefits. In a preferred approach the three-dimensional object comprises a three-dimensional cylinder.

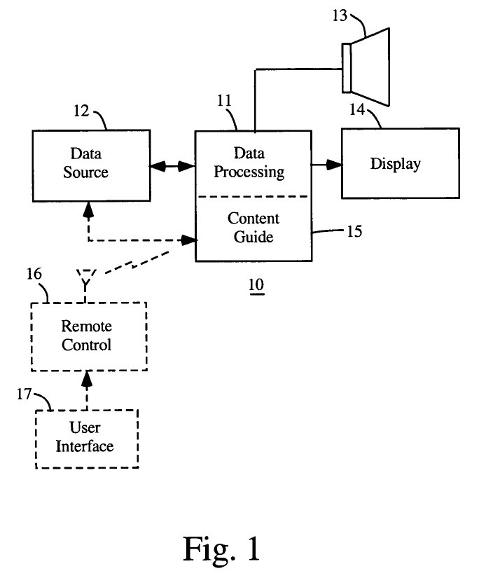

Referring now to the drawings, and in particular to FIG. 1, an apparatus 10 suitable to support and facilitate these teachings can comprise a data processing unit 11 that processes audio/visual information from a data source 12 (or sources) and provides corresponding audio information to an audio processing path 13 and video information to a two-dimensional display 14.

The control circuitry of the data processing unit 11 can be embodied in a variety of ways. For example, the data processing unit 11 can comprise a fixed-purpose dedicated platform or can comprise a partially or fully programmable platform. Such options and architectural alternatives are well understood in the art and need no further elaboration here. In some embodiments, as with a so-called cable or satellite set-top box, the data processing unit 11 can be readily realized through appropriate programming of the processor as typically accompanies such an apparatus.

The data source 12 can comprise any presently known or hereafter developed data source. In a preferred embodiment the data source 12 provides audio/visual content such as television programs and movies. Such a data source 12 can provide access to wireless broadcast reception services, cable or optical fiber services, and/or satellite services, to name a few (either alone or in conjunction with one another). Depending upon the needs of the application, it is also possible that the data source 12 provides access to discrete selectable items of audio/visual content as are embodied in a plurality of media. For example, the data source 12 may provide access to cable programming options, satellite programming options, and local programming options as may be available via one or more local or otherwise available media drives (such as but not limited to video tape drives or digital video disk (DVD) drives). It is also possible that the data processing unit 11 operably couples to a plurality of such data sources to permit access to corresponding programming services and viewing options.

In a preferred embodiment this apparatus 10 further comprises a content guide 15. This content guide 15 can comprise an integral part of the data processing unit 11 (as suggested by the illustration in FIG. 1) or can comprise a physically separate platform that operably couples to the data processing unit 11. The content guide 15 can receive information regarding programming options in any of a variety of ways. For example, the data source 12 itself can source such information (either via the data processing unit 11 or directly via a dedicated coupling between itself and the content guide 15 engine). As another example, the content guide 15 can obtain such programming information in other ways such as via a dial-up link (not shown) that facilitates access to a server that provides such information.

Such content guides are generally well understood in the art. The particular configuration and/or general operation of such engines is not especially important to these embodiments. Therefore additional detailed description will not be provided here regarding content guides except where appropriate below with respect to the description of these embodiments.

It will be understood that such apparatus 10 are often at least partially responsive to an optional wireless remote control 16. The latter often use infrared technology to facilitate communications but any wireless technology as may be appropriate to the needs of a given application can be utilized. In many instances such a remote control 16 will include a user interface 17 such as, for example, a keypad. Such a keypad will provide one or more keys that, when asserted by a user, will cause transmission of a particular corresponding wireless instruction or signal by the remote control 16. As another example, the user interface 17 can also comprise a so-called jog wheel that again, when manipulated by a user, will cause transmission of corresponding wireless instructions. Pursuant to a preferred embodiment, the operations of the content guide 15 will be at least partially configurable and/or otherwise controllable by appropriate remote control signals. Again, such remote controls are well understood in the art and require no further elaboration here.

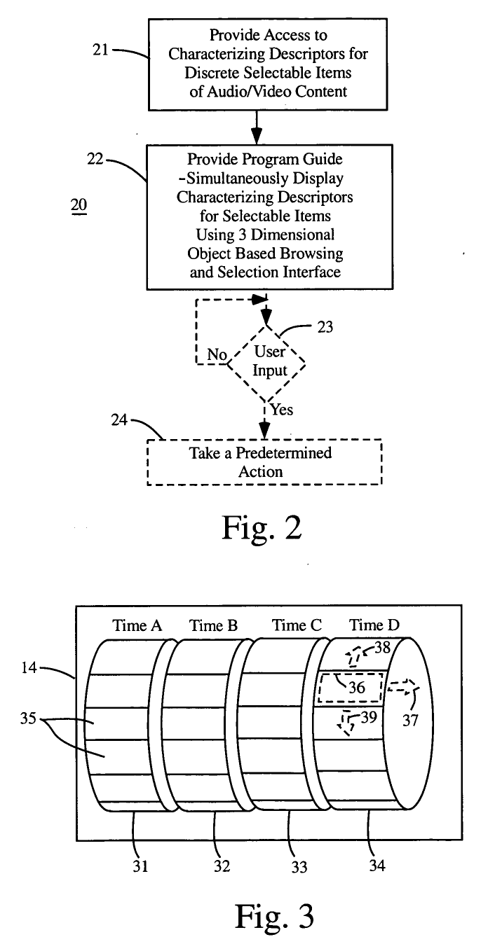

Referring now to FIG. 2, a process 20 that is readily supported by such an apparatus 10 (or that can be alternatively effected through any other suitable architectural configuration of choice) will be described. This process 20 provides for access 21 to characterizing descriptors as individually correspond to a plurality of discrete selectable items of audio/visual content (such as individual movies or television programs). The characterizing descriptors for such items of audio/visual content can be many and varied and can include, for example, a programming network identifier (such as the network call sign that will broadcast or otherwise source the particular program), a broadcast starting time (or stopping time) for the program, a description (such as a textual description) of (or that otherwise pertains to) the audio/visual work, and an indication of the content media source itself (such as whether the program is available by cable, satellite, local media, or the like). The characterizing descriptors can also include samples of the video (and/or audio content) of the item itself and/or a previously prepared trailer or other preview or promotional sample for the item.

The process 20 then facilitates provision 22 of a program guide by simultaneously displaying a plurality of the characterizing descriptors for each of a plurality of the discrete selectable items using a browsing and selection interface that bears at least some of the characterizing descriptors. In a preferred embodiment this browsing and selection interface has three spatial dimensions that are simultaneously displayed such that the browsing and selection interface is depicted as at least one three-dimensional object. In a preferred embodiment this three-dimensional object comprises a three-dimensional cylinder (or cylinders). This is not to say that the display itself must itself create an actual three-dimensional image (such as a hologram); rather, the browsing and selection interface comprises a two-dimensional depiction of a three-dimensional object.

As an illustration of this approach, and referring momentarily to FIG. 3, a display 14 of a compliant browsing and selection interface can be comprised of a plurality of cylinders 31, 32, 33, and 34 that are disposed co-axial to one another. Through the use of appropriate perspective, three spatial dimensions (i.e., length, width, and depth) for each cylinder is depicted. In this embodiment, the X-axis corresponds to a temporal domain. For example, programming times can become later as one moves to the right on this display, such that “TIME B” as corresponds to the second cylinder 32 represents a later time than “TIME A” as corresponds to the first cylinder 31. Also in this embodiment, the Y-axis corresponds to programming information. Each cylinder is parsed into segments 35, where each segment 35 can contain characterizing descriptors as pertain to a separate item of audio/visual content.

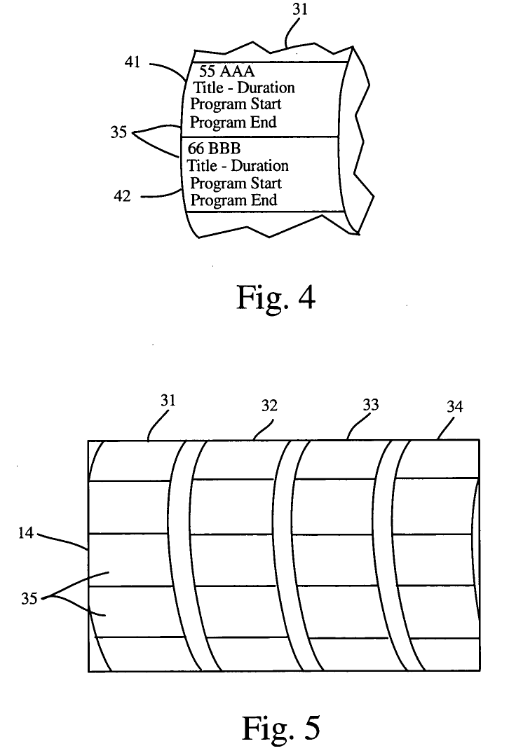

With momentary reference to FIG. 4, the particular characterizing descriptors selected for such display can be as many and as varied as may suit the needs of a given application. To provide but a single illustration, one segment 41 of a given cylinder 31 can include content source information (such as a channel number and call sign for that source), a title for the audio/visual program, an indication of the duration of the program, and the start and end times for the program, while another segment 42 can provide similar information for a different source/program.

Referring again to FIG. 3, it can be seen that a considerable quantity of characterizing information can be provided for a relatively large number of candidate programs for each of four (in this embodiment) different time frames (where, for example, “TIME A” could represent 6:00 PM, “TIME B” could represent 6:30 PM, “TIME C” could represent 7:00 PM, and “TIME D” could represent 7:30 PM).

Referring now again to FIG. 2, the process 20 can monitor 23 for input from a user. Such input can comprise any one or more of a variety of different input signals. Depending upon the embodiment, the viewer can provide such signals through use of a keypad and/or so-called jog wheel or other input mechanism as provided on a remote control or on the processing unit itself. Upon detecting such an input, the process 20 can then take 24 an appropriate predetermined action.

For example, and referring again to FIG. 3, when the user input comprises a selection action, a presently highlighted or pre-selected element on the display can be accordingly selected. An area of focus 36 can serve, in a preferred embodiment, to highlight a presently selectable displayed selection. Such focus capabilities are many and varied and are otherwise well understood in the art and include but are not limited to an overlying cursor icon, highlighting of the area of focus, use of reverse contrast, or application of a peripheral boundary indicator to visually indicate the area of focus. So configured, when the user enters a “select” signal, the programming candidate that corresponds to the present location of the area of focus 36 will be selected. Selection of a given programming option can result in an immediate display of that particular programming option, a scheduled recording of that programming option, or such other option as may be provided by a given system designer.

These embodiments will readily accommodate other user entries. In particular, the user may have entered a navigation instruction (for example, by asserting an arrow key, a cursor movement key, or by properly asserting a jog wheel, joystick, or other similar object position control mechanism in accordance with well established prior art practice). In this embodiment, when the navigation signal corresponds to movement in the X-axis, the area of focus will move from cylinder to cylinder (preferably next highlighting a next adjacent programming option segment on the next adjacent cylinder). For example, with respect to the present illustration, by asserting an instruction to move to the left, the area of focus 36 will move to the next adjacent segment on cylinder C 33.

In general, the number of potentially relevant time segments that are available will be more than can be reasonably displayed at a single time on such a display 14. In a preferred embodiment, a viewer can readily move to presently undisplayed time segments by attempting to move the area of focus to the left or right past a last presently displayed cylinder. For example, as illustrated, when a user asserts an instruction to cause a movement to the right 37, the four cylinders presently displayed can precess to the left, such that the first cylinder 31 will move off-display to the left and a fifth cylinder (as corresponds, for example, to “TIME E”) will appear on the far right of the display 14. (Other alternatives are of course possible. As one example, all of the cylinders can be replaced, four at a time, in a page-by-page fashion, rather than by moving and replacing the cylinders one at a time as described.) Such an approach readily permits a viewer to access and interact with data as corresponds to time periods other than those that are immediately reasonably presentable.

When detecting a user instruction to move up or down, the area of focus can instead move up or down, respectively, to a next adjacent segment on the same cylinder. As illustrated, for example, the area of focus 36 can be moved upwardly 38 or downwardly 39 to other segments on the same cylinder 34 to thereby highlight and/or ultimately select corresponding program options. As with time periods, there may be more program options available for a given time period than can be reasonably presented at once on such a display. In such a situation, continued instructions to cause the area of focus to continue to move upwardly or downwardly will eventually cause the area of focus to reach the displayed top or bottom of that cylinder. Providing an instruction at this point to continue moving the area of focus in the same direction will preferably cause that cylinder to appear to rotate and thereby move new segments and hence information regarding new program options into view. In a preferred embodiment, the cylinder can be caused to rotate in this manner in either direction to accord with a present direction of movement of the area of focus.

In the embodiments just described, the area of focus moves with respect to the segments of a given cylinder, and the cylinder then moves with respect to the area of focus when necessary to bring additional program option information to the display. Such an approach may be suitable and effective for many applications. For other situations, however, it may be desirable to maintain the area of focus at a relatively stable position (such as in the middle of the cylinder/display). The viewer can cause the area of focus to move horizontally from cylinder to cylinder as described above. Vertical movement instructions, however, do not cause movement of the area of focus with respect to its relative position on the display 14. Instead, in this embodiment, the cylinder turns immediately with each vertical movement instruction to thereby move a new segment (and hence characterizing descriptors for a given corresponding item of audio/visual content) into the area of focus.

Regardless of the mode of operation utilized, the 3-dimensional representation of the cylindrical object(s) that bears the characterizing descriptors serves to suggest its own rotatability and hence intuitively suggests to a user the means whereby the user can bring the area of focus to a desired program option. Other visual elements could be added, if desired, to enhance or otherwise support this impression (for example, arrows or a visually apparent axle could be used in this fashion). In addition, or in the alternative, audio cues could be used to further enhance these impressions or user experience. For instance, visual rotation of the cylinders could be accompanied by a sound that is suggestive of a rotating object to thereby reinforce the visual impressions being received by the viewer.

In the embodiments described above, the browsing and selection interface comprised a three-dimensional object that was essentially fully presented on the available display. It would of course be possible to present such an object in a manner where the object is not fully visible. An illustrative example appears at FIG. 5.

These embodiments also present the object as comprising a cylinder. Although a cylinder may comprise a preferred configuration for many applications, other shapes can also be used. Example shapes include a rectangle-shaped bar, hexagon or octagon-shaped discs, and even more exotic shapes such as stars and the like.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

1. A method comprising:
providing access to a plurality of characterizing descriptors for each of a plurality of discrete selectable items of audio/video content;
providing a program guide by simultaneously displaying a plurality of the characterizing descriptors for each of a plurality of the discrete selectable items using a browsing and selection interface that bears at least some of the characterizing descriptors and wherein three spatial dimensions for the browsing and selection interface are simultaneously displayed, such that the browsing and selection interface is depicted as at least one three dimensional object.

2. The method of claim 1 wherein the browsing and selection interface is displayed on at least one three dimensional cylinder.

3. The method of claim 1 wherein the plurality of discrete selectable items of audio/video content are embodied in a plurality of media.

4. The method of claim 1 and further comprising:
responding to a remote control device by scrolling a display of the plurality of the characterizing descriptors for each of a plurality of the discrete selectable items.

5. The method of claim 4 and further comprising:
responding to a remote control device by altering the display of the plurality of the characterizing descriptors for each of a plurality of the discrete selectable items on a page basis.

6. The method of claim 1 and further comprising:
responding to a remote control device by signaling user selection of a particular one of the discrete selectable items of audio/video content.

7. The method of claim 6 and further comprising:
sending a signal indicating user selection of the particular one of the plurality of discrete selectable items of audio/video content.

8. The method of claim 1 and further comprising:
using a jog dial to do at least one of:
scrolling a display of the plurality of the characterizing descriptors for each of a plurality of the discrete selectable items;
paging a display of the plurality of the characterizing descriptors for each of a plurality of the discrete selectable items

9. An interactive program guide system comprising:
characterizing descriptors for each of a plurality of discrete selectable items of audio/video content;
control circuitry that displays a plurality of the characterizing descriptors using a browsing and selection interface that bears at least some of the characterizing descriptors and wherein three spatial dimensions for the browsing and selection interface are simultaneously displayed, such that the browsing and selection interface is depicted as at least one three dimensional object.

10. The interactive program guide system of claim 9 wherein the browsing and selection interface is displayed on at least one three dimensional cylinder.

11. The interactive program guide system of claim 9 wherein the plurality of discrete selectable items of audio/video content are embodied in a plurality of media.

12. The interactive program guide system of claim 9 and further comprising:
a remote control device; and
wherein the control circuitry is operably responsive to the remote control device.

13. The interactive program guide system of claim 9 and further comprising:
a jog dial; and
wherein the control circuitry is operably responsive to the jog dial.
